(19) United States
(12) Patent Application Publication
(10) Pub. No.: US 2005/0218059 A1
(43) Pub. Date: Oct. 6, 2005

(54) Fluid filter mounting apparatus and method

(76) Inventor: George Knoll, Belvidere, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/812,745

(22) Filed: Mar. 30, 2004

(51) Int. Cl. B01D 27/00

(52) U.S. Cl. 210/232

(57) ABSTRACT

A fluid filter mounting apparatus includes a mounting bracket having a fluid intake and a fluid output, a first manifold and second manifold within the mounting bracket, each of the first manifold and the manifold having a fluid inlet and a fluid outlet. The fluid intake of the mounting bracket is in fluid communication with the fluid inlet of the first manifold. The fluid outlet of the first manifold is in fluid communication with the fluid inlet in the second manifold and the fluid outlet of the second manifold is in of fluid communication with the fluid output of the mounting bracket. A first mounting throughhole and a second mounting throughhole in the bracket are each dimensioned to align a first cartridge housing and a second cartridge housing with each of the first and second manifolds. Each of the throughholes are also dimensioned to secure a first portion of the filter cartridge housing when a closure member of the filter cartridge housing is seated in the manifold.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

1. Field of the Invention

The present invention is a fluid filter cartridge mounting bracket with manifolds and a method for their assembly and for replacing cartridges.

2. Related Art

Fluid filters, particularly water filters, are known. Drinking water filters adapted for use with plumbing in buildings where people work or live is common in many areas. A variety of filter types can be used, including charcoal, other granular types of filters or pleated membranes and the like. After any filter has been used for a period of time, it becomes less effective as impurities build up within it. Accordingly, filter systems need to provide for filter replacement.

U.S. Pat. No. 5,336,406 to Stanford et al. is typical of a prior art filter system having a replaceable cartridge. One problem addressed by the Stanford patent is to prevent leakage of water during the replacement of a filter and/or a cartridge containing the filter. The Stanford reference discloses a spring loaded check valve for closing a water source pipe when a cartridge is removed from a manifold that holds it when in use. However, the prior art leaves unaddressed multiple continuing problems. For example, in the Stanford patent, only the water intake is stopped by the valve during replacement. There is a need in the art for stopping not only pressurized water inflow during cartridge replacement but also back flow from the water outlet side of the manifold.

Another continuing need in the art is protecting filter components from damage or misalignment during installation. For example, the filters themselves within cartridges typically have an outlet tube or other extension designed to engage an outlet in the manifold. Filters, filter outlet tubes, seals, O-rings and the like can all be damaged or misaligned during installation when prior art designs are used. There is a continuing need in the art for a more durable design for a cartridge closure member and its seating within a manifold receptacle for it.

Leakage of fluid during cartridge replacement is increased by the failure of the prior art designs to relieve input fluid pressure on closure components during cartridge replacement, particularly in relation to outflow pressure release. Leakage would be reduced and water pressure shock to a new filter is also reduced by providing pressure release through a fluid outlet sequentially with re-pressurization through a fluid inlet. However, no existing system achieves this.

There also remains a continuing need to avoid further damage or misalignment by a users repeated manual adjustment of the cartridge within the manifold caused by the users' inability to determine when a cartridge closure member has been properly seated in the manifold. There further remains a need for an ergonomically designed cartridge having a shape making it intuitively clear to a user how a cartridge properly seats in a manifold.

There is also a need in the art for allowing a user the option of replacing an entire cartridge, or simply a filter within the cartridge.

There is a continuing need in the art for a manifold and cartridge assembly easily assembled with existing plumbing, as for example, with manifold inlet and outlets being in line.

Currently in the art mounting manifolds for filter cartridges have only rudimentary installation mounting components. There is a need for an improved mounting system for installing filter systems on walls or under cabinets. There is a need for a mounting bracket that properly aligns a filter cartridge when it is mounted in a manifold and securely holds the mounted cartridge in place. There is a need for mounting two filter cartridges in line. There is a need for locking mounts.

### SUMMARY OF THE INVENTION

It is in view of the above problems that the present invention was developed. A fluid filter mounting apparatus includes a mounting bracket having a fluid intake and a fluid output, a first manifold and second manifold within the mounting bracket, each of the first manifold and the manifold having a fluid inlet and a fluid outlet. The fluid intake of the mounting bracket is in fluid communication with the fluid inlet of the first manifold. The fluid outlet of the first manifold is in fluid communication with the fluid inlet in the second manifold and the fluid outlet of the second manifold is in of fluid communication with the fluid output of the mounting bracket. A first mounting throughhole and a second mounting throughhole in the bracket are each dimensioned to align a first cartridge housing and a second cartridge housing with each of the first and second manifolds. Each of the throughholes are also dimensioned to secure a first portion of the filter cartridge housing when a closure member of the filter cartridge housing is seated in the manifold.

The present invention is depicted as adapted for a water filter system, apparatus and method having a manifold designed for installation with a pressurized fluid input pipe and an outlet pipe. The present invention includes a manifold and a replaceable cartridge. The cartridge is comprised of a housing dimensioned to contain a filter. In the housing may have a base end that is removable, or fixed to the housing. The cartridge having a removable base, a filter may be replaced in the cartridge and the cartridge reused. The alternative design not having a removable base, the cartridge may be removed and replaced from the manifold of the filter system, but the filter may not be replaced within the cartridge housing. In either case, any of a wide variety of known filters may be installed within the housing of the cartridge.

The cartridge also includes a closure member. The closure member is integrally formed with the filter housing. The housing, in some aspects of the present invention, may be tapered, to ease proper installation.

The manifold, in one embodiment of the present invention, is designed for inline installation on a preexisting plumbing line. That is, the input and output pipes would be substantially level. The manifold has an inlet stop and outlet stop. The stops may be any of a wide variety of stop valves, check valves or other devices for leakage free closure of a fluid transport line. The manifold inlet and manifold outlet are in fluid communication with seats for the cartridge closure member. The stops for the inlet and outlet are incorporated with the inlet and outlet such that an actuating projection of the stops extends into the seat for the closure member.

Both the convex extension of the closure member and the corresponding concave seat of the manifold are designed with two levels. The radial dimensions of each level are different. In the depicted embodiments, each level has an annular axial face, having an annular seat for an O-ring to seal the closure member in the manifold seat. A second level of the closure member is coaxial with and disposed on the top of the first level. It also has an annular seat for an O-ring. The first level includes radial intake ports for receiving pressurized input of water or other fluids. The intake ports are on the vertical, annular side wall of the first level. The top level has an outlet port, located on its top, so that fluid outlet is in an axial direction.

Each level of the closure member also includes at least one boss or tab. This boss or tab has at least one ramped face in the depicted embodiments. The bosses are fabricated and oriented to engage the inlet and outlet stop projections when the cartridge is installed in the manifold seat. The bosses are further fabricated and oriented in relation to one another so that upon installation, the outlet stop is engaged to open first and the inlet stop is engaged to open last. Thus, on installation, the outlet valve is already open when the inlet valve is opened, avoiding pressure shocks to the filter alignment and avoiding leakage. The order is reversed when the cartridge is being removed. The bosses close the fluid intake stop valve first, and close the fluid outlet stop second, also suppressing leakage and discontinuous pressure transitions.

The inlet ports on the cartridge are larger than the outlet port in total intake area and volume capacity. The inlet ports may be two or more in number, or may be a single large port. In the depicted embodiment, two ports are used. These configurations ensure that fluid taken in is evenly distributed around a filter within the filter housing.

Separately from the stop valve actuation bosses, the closure member and manifold further have ramped lugs dimensioned to cooperate with each other. These mounting lugs thread together to provide for a 90° turn screw fit. The inlet ports, stop valve bosses and mounting lugs are oriented symmetrically, so that a simple twisting motion will mount the cartridge in the manifold. Another boss and detent on the ramped lugs provide a positive stop, imparting a desirable “snap” sensation to a user, confirming proper installation.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a cutaway front view of the manifold cartridge assembly of the present invention;

FIG. 2 is a cutaway side view of the manifold cartridge assembly of the present invention;

FIG. 3 is a cutaway front view of the cartridge of the present invention;

FIG. 4 is a cutaway side view of the cartridge of the present invention;

FIG. 5 is a cutaway close up front view of the closure member of the present invention;

FIG. 6 is a cutaway close up side view of the closure member of the present invention;

FIG. 7 is a top view of the cartridge of the present invention;

FIG. 8 is a schematic close up top view of the cartridge of the present invention;

FIG. 9 is a front view of the closure member of the cartridge;

FIG. 10 is a cutaway side view close up of a stop valve for the present invention;

FIG. 11 is a perspective view of the base cap of the present invention;

FIG. 12 is another view of the closure member;

FIG. 13 is a side view of the closure member installed in the manifold;

FIG. 14 is a cut away side view of the manifold;

FIG. 15 is a side view of the manifold;

FIG. 16 is an opposite side view of the manifold;

FIG. 17 is a perspective top view of the mounting bracket;

FIG. 18 is a perspective bottom view of the mounting bracket;

FIG. 19 is a top view of the mounting bracket;

FIG. 20 is a cut away side view of the mounting bracket;

FIG. 21 is a perspective top view of the mounting bracket as installed;

FIG. 22 is another perspective top view of the mounting bracket as installed;

FIG. 23 is a perspective top view of the mounting bracket during assembly;

FIG. 24 is a perspective view of a bottom of the mounting bracket incorporating a lock;

FIG. 25 is a perspective view of the mounting bracket incorporating a lock and cap;

FIG. 26 is a cut away view of the mounting bracket incorporating a lock and cap; and

FIG. 27 is a perspective view of the mounting bracket incorporating a lock with alternative cap.

### DETAILED DESCRIPTION OF THE PREFERRED EMBODIMENTS

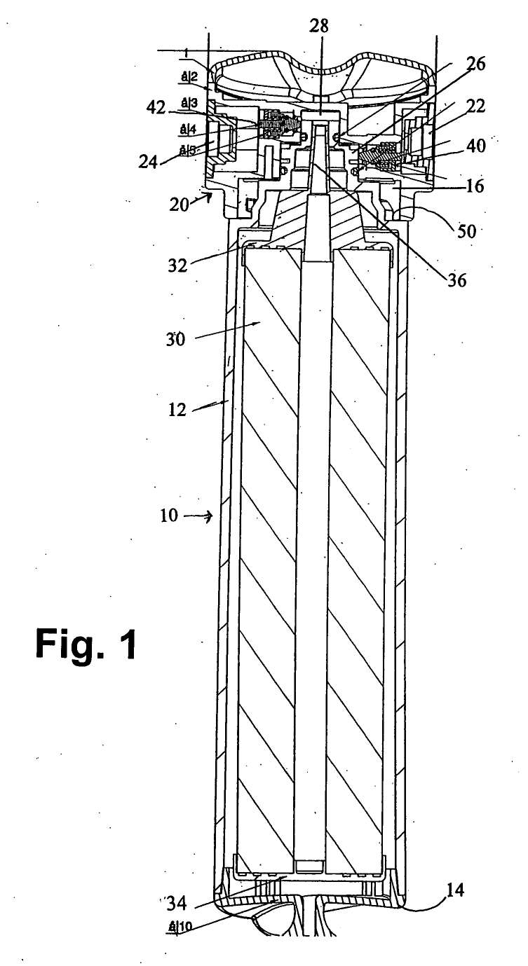

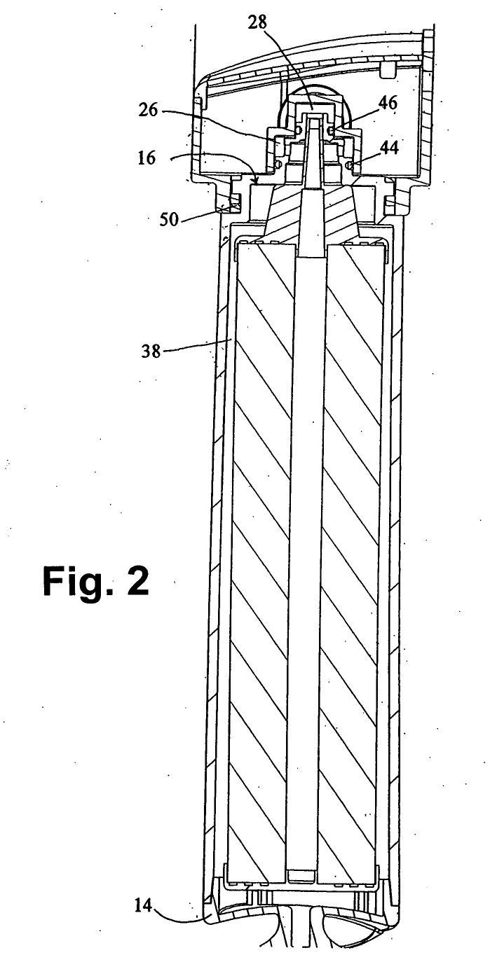

Referring to the accompanying drawings in which like reference numbers refer to like elements, FIG. 1 is a cutaway front view of the fluid filter manifold and cartridge assembly of the present invention. FIG. 2 is a cutaway side view of the same. Cartridge 10 is depicted as installed in manifold 20. The aspects of cartridge 10 include housing 12 base 14 and a closure member, indicated generally at 16.

Manifold 20 includes a fluid intake 22 and a fluid output 24. Intake 22 and output 24 are adapted to be installed with standard plumbing fittings in manners that will be recognized by those with skill in the art. Within manifold 20 are a first seat level 26 and second seat level 28.

Inside the housing 12 are a filter 30 assembled with a filter end cap 32 and filter base 34. The filter end cap 32 has a projecting filter output tube 36. In the depicted embodiment, a space 38 is provided between housing wall 12 and filter 30 for water flow. It is within the scope of the present invention that water flow filter and housing interior configurations within housing 12 may be varied.

Visible in FIG. 1 is an intake stop valve 40 and output stop valve 42. It is within the scope of the present invention that a variety of displaceable, fluid tight stops may be used. In the depicted embodiment, the stops are biased into a seat by springs and have O-rings seals, as described in more detail below.

Also visible in FIGS. 1 and 2 are O-rings seals for assembly in annular grooves in the closure member. They are disposed to sealingly engage the manifold first seat level 26 and second seat level 28 when cartridge 10 is fully installed in manifold 20. First O-ring 44 and second O-ring 46 seat in and seal the first level seat 26 and second level seat 28, respectively, when cartridge 12 is fully installed in manifold 20. Moreover, the seals and bosses of the closure member are dimensioned to seal before the bosses open the intake and output stops.

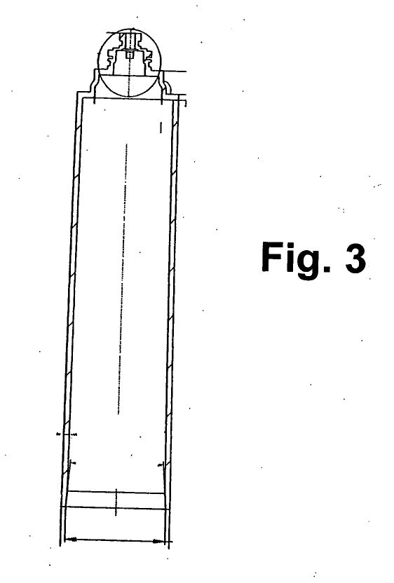

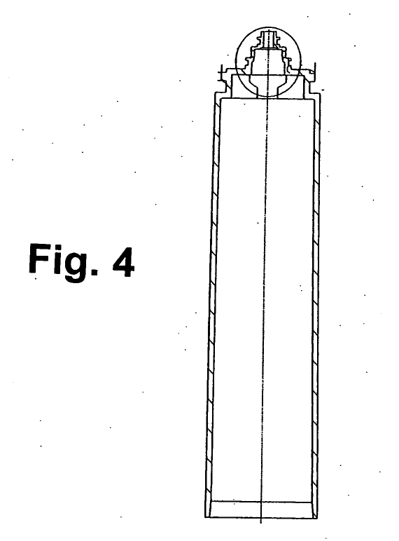

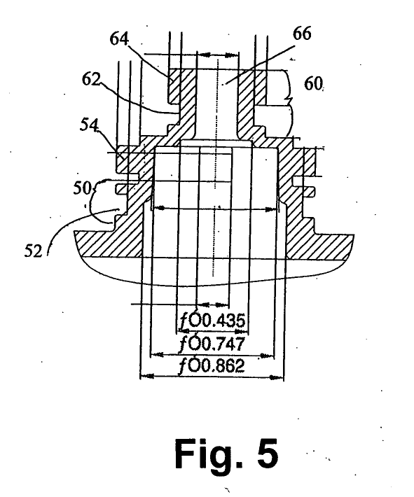

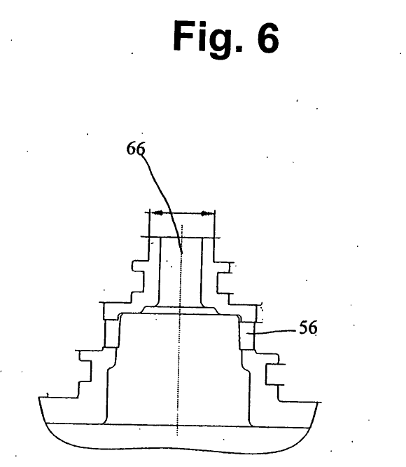

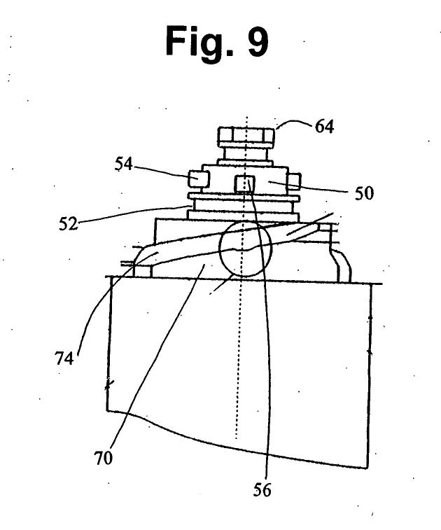

FIGS. 3 and 4 are a cutaway front view and side view, respectively, of the filter cartridge 10 without the filter 30 or the manifold 20 depicted. FIGS. 5 and 6 are a cutaway front view and cutaway side view, respectively, depicting a close up of the closure member that together with the housing comprise the cartridge 20. The closing member and housing may be attached, as by spin welding, or integrally formed. FIG. 9 is a front view of the closure member of the cartridge. As is best seen in FIGS. 5 and 9, the closure member has a first level 50 including an O-ring seat 52 and opposing bosses 54. Also on first level 50 of the closure member is a fluid intake port 56. As can be seen, the fluid intake port 56 is oriented in a lateral direction, opening radially through the vertical, annular wall of the first level 50 of the closure member. Also shown on FIG. 9 is a mounting level 70 of the closure member.

Also visible in FIGS. 5 and 9 is an upper level 60 of the closure member. Included in the upper level is annular O-ring seat 62 and opposing bosses 64. A fluid outflow port 66, for exit of the filtered fluid is also depicted in FIGS. 5 and 6. Outflow port 66 is on top of upper level 60 and fluid flows out of the cartridge axially.

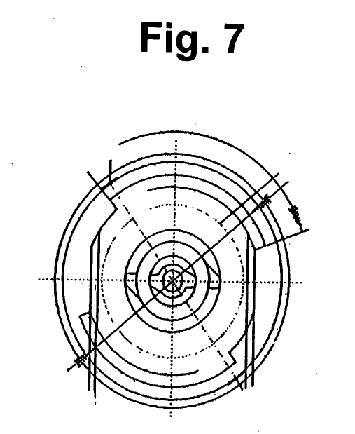

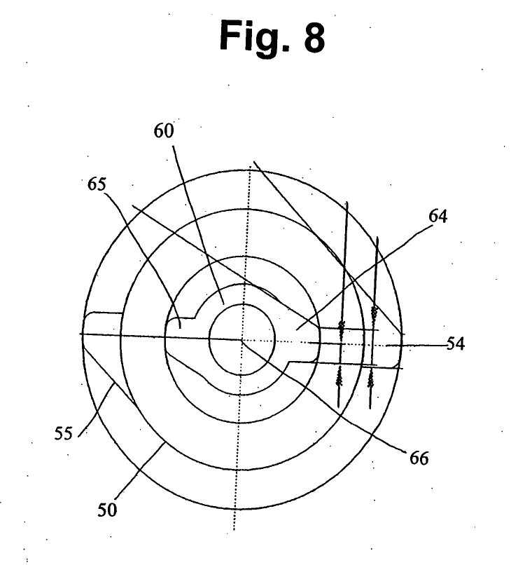

FIG. 7 is a top view of the closure member of the cartridge. FIG. 8 is a close up schematic view of the closure member of the cartridge. As is best seen in FIG. 8, lower bosses 54 and upper bosses 64 project radially from a center axis of the cartridge.

Also visible on FIG. 8 are the configurations of the engaging face of each boss. The cartridge 10 is installed in the manifold 20 with a twisting motion which is a 90° turn in the depicted embodiment. The engagement of the cartridge in the manifold by this motion is described in more detail below. As the cartridge 10 is twisted into its installed, seated position, the bosses 54 and 64 engage the intake and output stops, opening them as the cartridge is rotated into place. The engaging faces are slanted. As is best seen in FIG. 8, the engaging face 55 of lower boss 54 is at a different angle than at the engaging face 65 of upper boss 64. As will be readily appreciated by those with skill in the art, the steeper ramp, that is the engaging face which is at a more acute angle from the lateral horizontal axis depicted in FIG. 8, will engage and drive open the projection of a stop before the more gradual ramp opens its corresponding stop. The lower face 55 of lower boss 54 is the more gradual ramp. It is at a more oblique angle to the horizontal lateral axis of FIG. 8. Accordingly, rotation of the closure member 16 will open the top valve with boss 64 before the bottom valve is opened by boss 54. As depicted, installation of the cartridge will open the outlet first and inlet second upon installation. Conversely, the depicted closure member will close the inlet first and close the outlet second upon removal of the cartridge from the manifold.

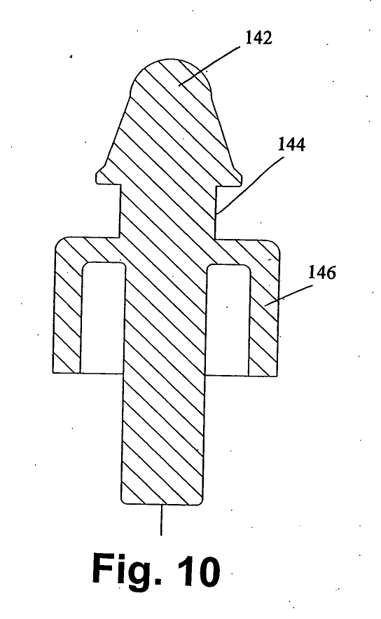

FIG. 10 is a close up, cross sectional view of the stop valve used for both the manifold inlet and outlet. It is comprised of a projecting head 142 which in the valves closed position extends into the manifold seat 26 or 28, where it is disposed to be engaged by bosses 54 or 64. The stop valve also includes an annular seat for an O-ring 144 in order to produce a water tight seal when closed. It also includes a spring seat 146 having a recess into which a coil spring is assembled. It is within the scope of the present invention that any stop, stop valve or check valve may be used, provided it extends into the seat recesses 26 or 28 in a manner that can be engaged by bosses 54 or 64 in order to open or close the valve upon rotation of the cartridge 10.

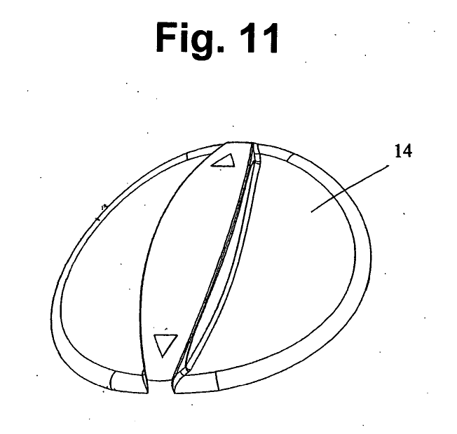

FIG. 11 is a perspective view of the base cap for the cartridge. In one embodiment of the present invention, the base cap is fixedly attached to the bottom of the housing 12. The attachment may be by any manner, for example, by spin welding. In an alternative embodiment of the present invention, the base cap 14 is removable. In such an embodiment of the present invention a user would have the option of replacing the entire cartridge or in the alternative, removing the cartridge, opening the cartridge housing by removing the base cap 14 and replacing the filter 30. The base cap could then be replaced and the cartridge reinstalled with the new filter. This procedure may be desirable in order to replace the used filter, or change the filter element from one type to another. This alternative embodiment also has the possible advantages of economy, as a filter may cost less than a filter and cartridge together. It may also provide a user perceived ecologic advantage, since less material will be discarded if the only the filter, as opposed to the filter and cartridge together, are disposed of after use.

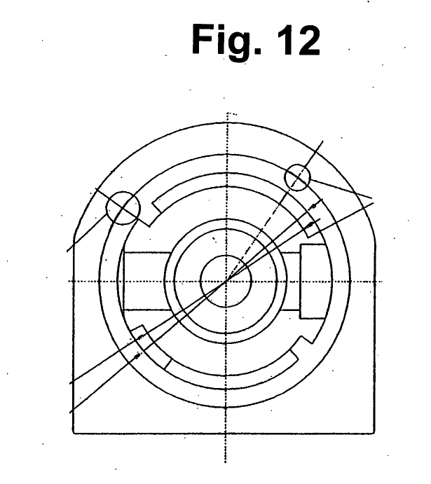

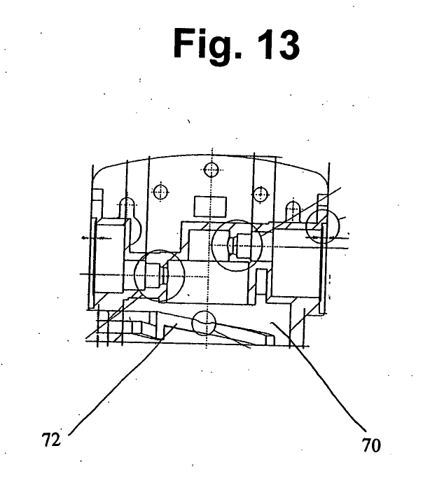

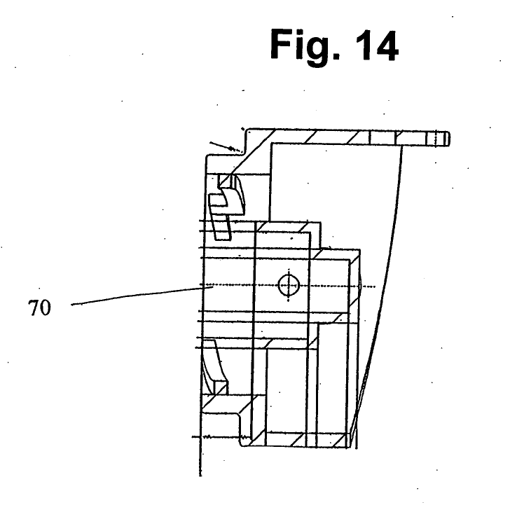

The depicted embodiment of the present invention provides for a 90° twist turn movement for installing and removing the cartridge 10 into and from the manifold 20. Other degrees of rotation or other means of installation are within the scope of the present invention, provided that the closure member engages the stop valves sequentially. In the depicted embodiment, as is best seen in FIGS. 12, 13 and 14, angled threads or lugs are formed within a mounting recess 70 in manifold 20. Thread lugs 72 in the recess of manifold 20 correspond to cooperating thread lugs 74 on the closure member of the cartridge.

The ramped or threaded lugs 72 and 74 on the closure member and mounting recess are dimensioned to engage each other in close sliding cooperation. They also include an end stop on either or both lugs. Finally, either one or the other of ramped lugs 72 or 74 will have a boss, positioned to engage a detent on the other of threaded ramps 72 or 74. The boss and detent are aligned to engage when the cartridges properly installed and fully closed and mounted in the manifold. The boss and detent provide a positive “snap in” feel to the user indicating that the cartridge is properly installed and further and manipulation by the user is not necessary.

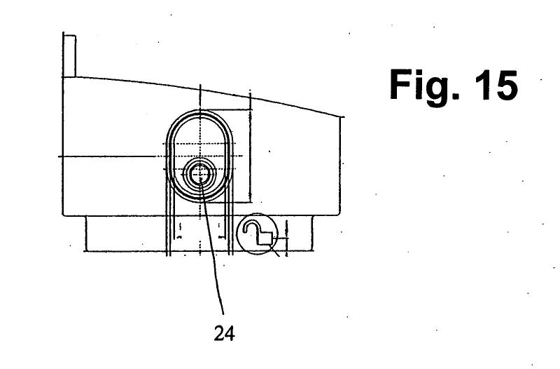

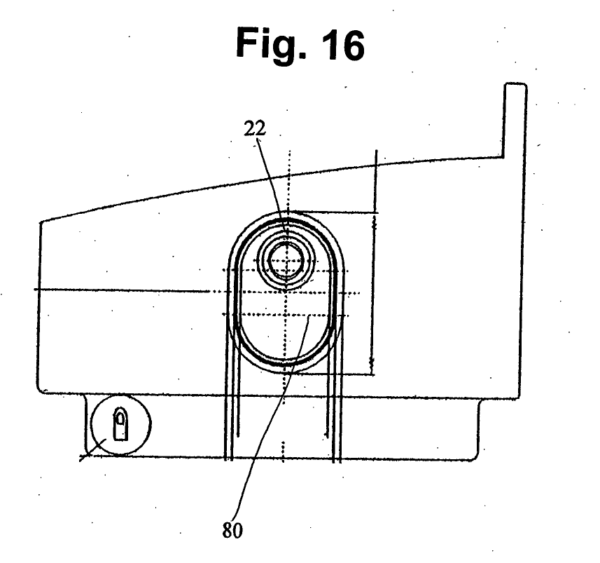

FIGS. 15 and 16 are side views of the manifold 20. They show inlet 22 and outlet 24. In order to ease installation of the manifold and to make it compatible with most existing plumbing systems, offset oval inserts 80 receive parallel installation of an inline pipe and direct the fluid flow to or from that pipe to properly engage the inlet and outlet of the manifold.

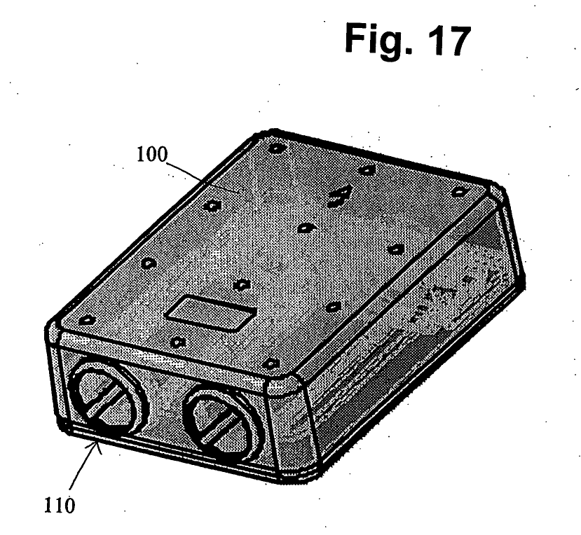

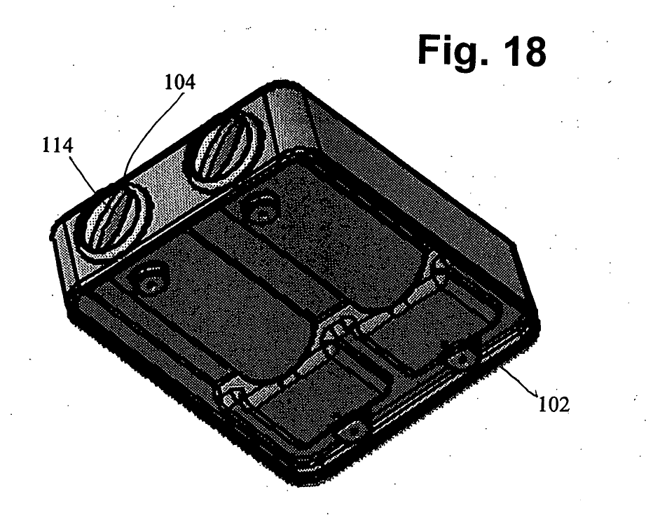

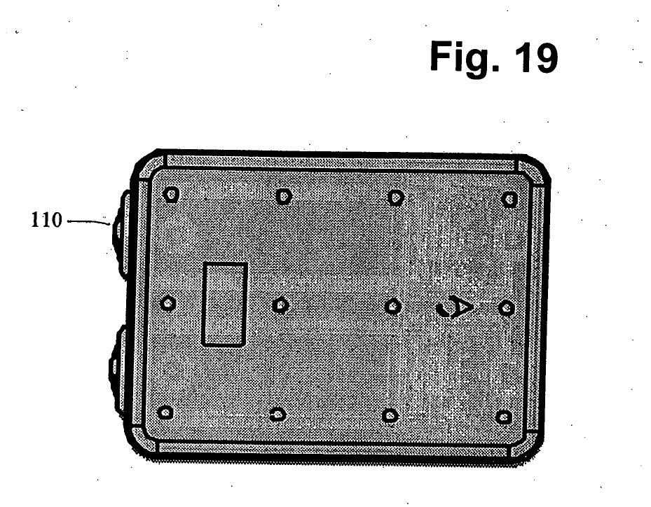

FIGS. 17, 18 and 19 are two perspective views and a top view, respectively, of the dual filter mounting bracket, 100. This bracket may be mounted on the wall and is designed to filter multiple lines, or provide dual or complimentary filtering capabilities for a single line. The bracket 100 is fabricated to incorporate two manifolds 120 and to receive installation of two cartridges 110. In this embodiment of the invention, it is particularly advantageous for the housing portion 112 of the cartridge 110 to be tapered. For removal, the base plate 114 is turned manually by grasping its fin, and then the cartridge as a whole 110 is removed from the bracket 100. A new cartridge is inserted in the hole 104 provided for it and slid upwards until it engages one of the manifolds 120. By tapering the cartridge 110, a proper alignment of the cartridge with the manifold 120 is promoted.

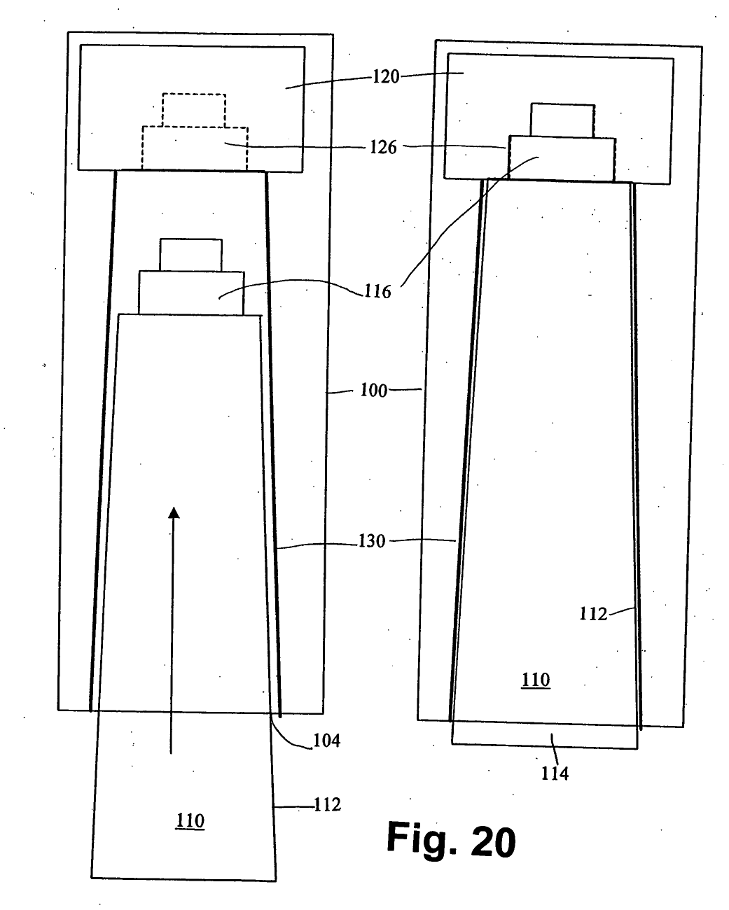

FIG. 20 is a schematic, cutaway side view of the filter system as installed with a mounting bracket 100. FIG. 20A shows a cartridge 110 being installed in FIG. 20B shows the cartridge 110 in its installed position. The closure member 116 of the cartridge 110 seats in the seating recesses 126 of the manifolds 102, as described above. In these schematic figures, the taper of the filter housing 112 of the cartridge 110 is slightly exaggerated for clarity. As can be seen, the hole 104 provided for insertion of the cartridge 110 in bracket 100 is larger than the closure member 116 or the end of the filter housing 112 closest to the closure member. The hole is as wide as the bottom end of the filter housing 112. Thereby, simply through the combination of the manifold seating 126 in its cooperation with closure member 116, combined with the dimensioning of hole of 104 to correspond to the bottom end of filter housing 112, the taper incorporated into cartridge 110 facilitates installation, proper alignment and minimization of installation damage to filter end tubes, O-rings or other seals.

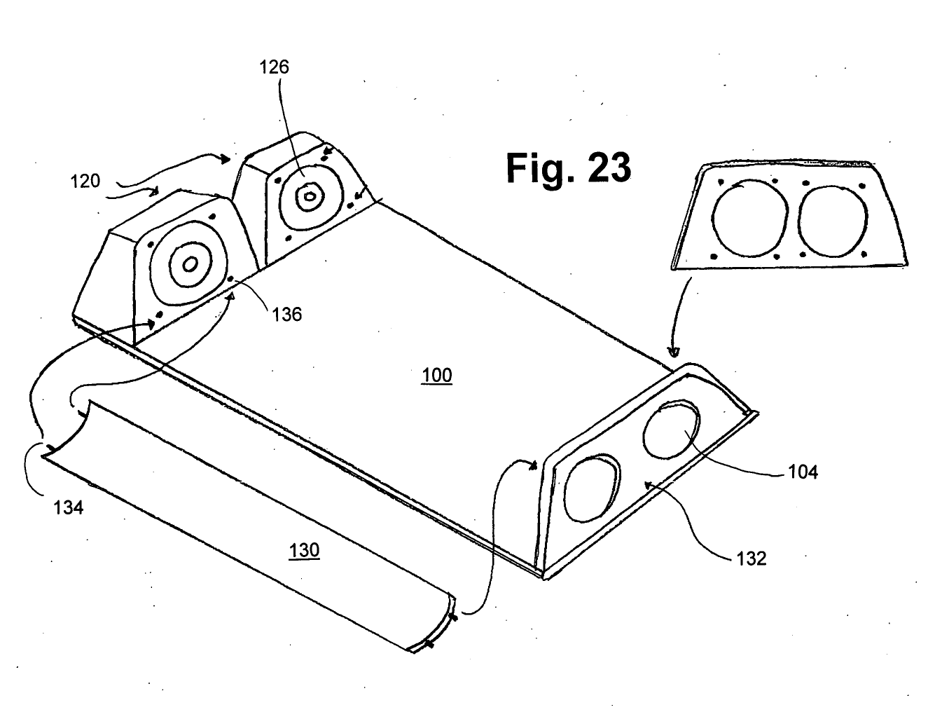

In addition, mounting sleeves 130 are incorporated into the bracket 100 in the depicted embodiment. As is best seen in FIG. 23 the cartridge sleeves are assembled together with the mounting bracket 100 such that they will affirmatively guide a tapered cartridge 110 into its proper seating alignment. In the depicted embodiment, a top sleeve and a bottom sleeve are assembled with manifolds 120 and a bottom plate 132 of the bracket 100 by any suitable means. In the depicted embodiment, pins 134 are used. Pins 134 correspond to holes 136 in manifolds 120 for assembly. As is seen in FIGS. 20A and 20B, sleeves 130 further assure an easy installation and affirmative guidance of the cartridge 110 into a properly seating with manifolds 120.

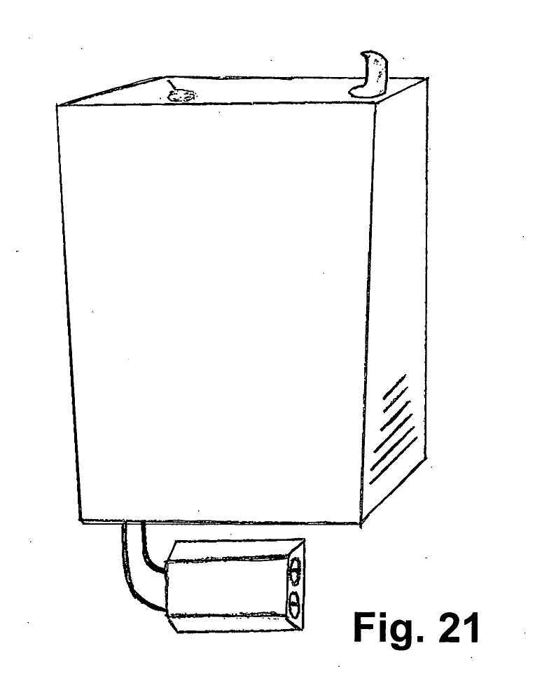

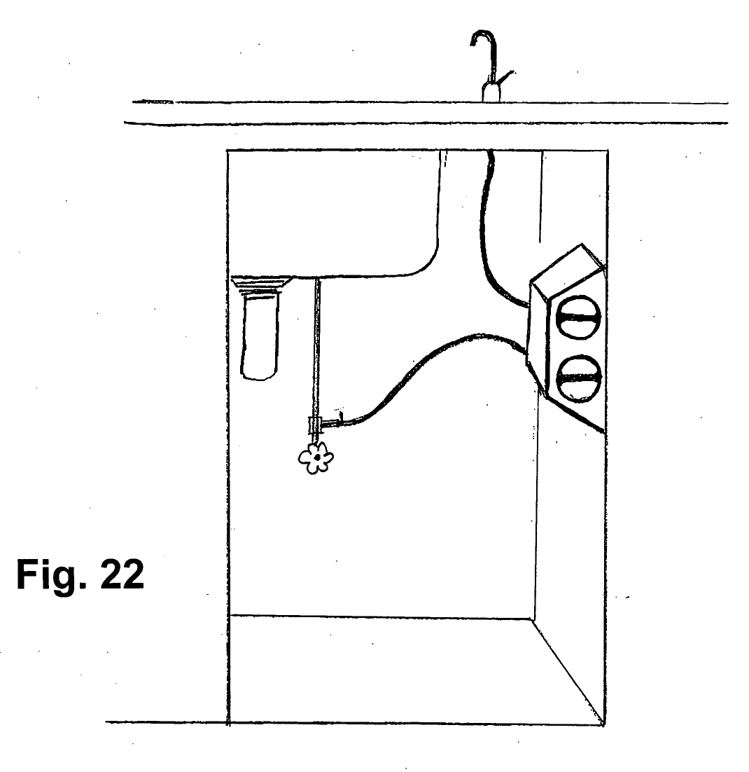

FIGS. 21 and 22 show the two filter mounting bracket as installed in two example uses. In FIG. 21 a drinking fountain is depicted and in FIG. 22 an under sink drinking water mounting is depicted.

Locking Embodiment

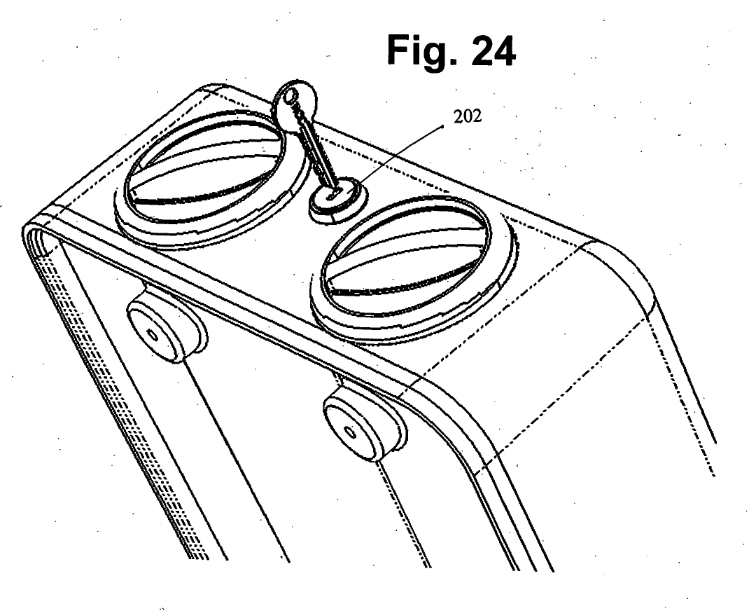

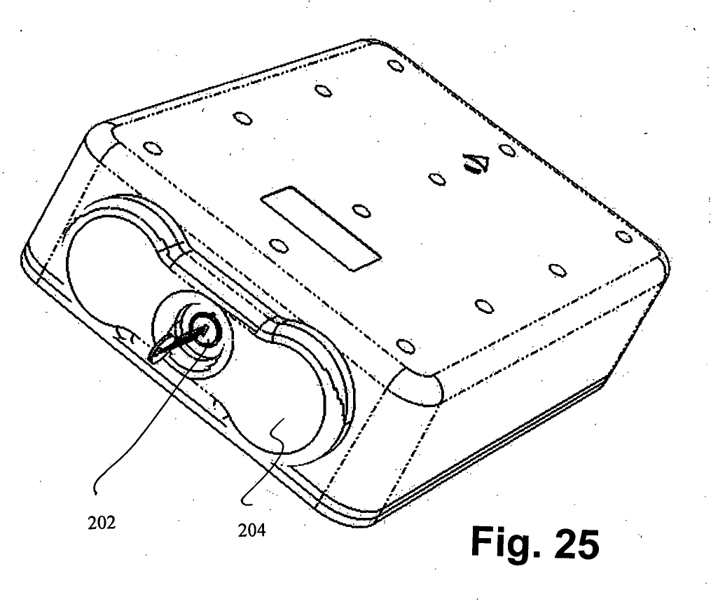

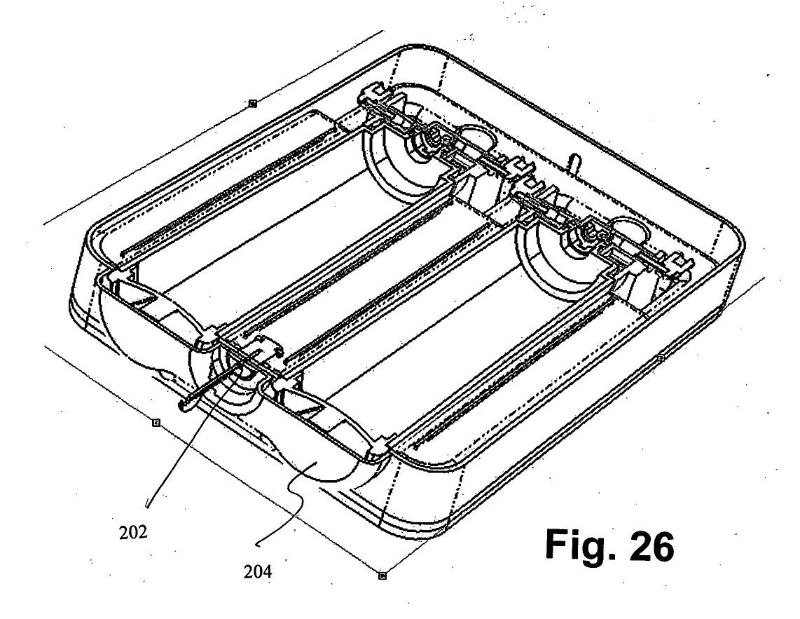

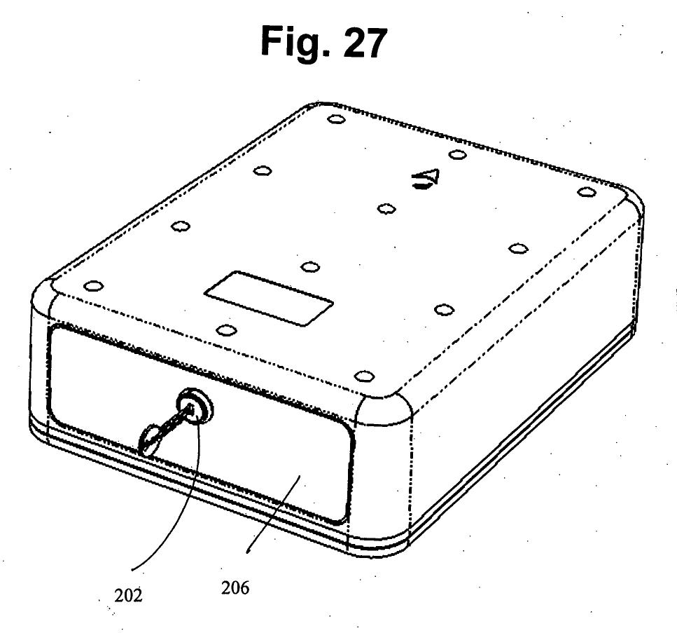

FIGS. 24 through 27 disclose locking alternative embodiments of the mounting bracket of the present invention. FIG. 24 is a perspective view of the mounting bracket including a lock 202. Internal to the bracket is a lock latch (not shown) engageable with a lock catch (not shown) within the bracket in order to lock it closed. FIGS. 25 and 26 show a mounting bracket having a cap formed to cover the base ends of the filter cartridge housings. The end cap also includes a lock 202. FIG. 27 discloses an alternative type of end cap, also covering the base ends of the cartridge housings and also having a lock 202.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A fluid filter mounting apparatus comprising:
a mounting bracket having a fluid intake and a fluid output;
a first manifold and second manifold within said mounting bracket, each of said first manifold and said second manifold having a fluid inlet and a fluid outlet;
said fluid intake of said mounting bracket being in fluid communication with said fluid inlet of said first manifold, said fluid outlet of said first manifold being in fluid communication with said fluid inlet in said second manifold and said fluid outlet of said second manifold being in fluid communication with said fluid output of said mounting bracket;
a first mounting throughhole and a second mounting throughhole in said bracket, each of said first and second mounting throughholes being dimensioned to align a first cartridge housing and a second cartridge housing with each of said first and second manifolds;
each of said throughholes being dimensioned to secure a first portion of the filter cartridge housing when a closure member of said filter cartridge housing is seated in at least one of said first or second manifolds.

2. The fluid filter mounting apparatus of claim 1 further comprising:
a first filter cartridge having a closure member adapted to sealingly mount in said first manifold and said first filter cartridge having a first filter cartridge housing dimensioned to securely maintain said seating by a close cooperation of an outer dimension of a first portion of said first filter cartridge housing with an inner dimension of said throughhole; and
a second filter cartridge having a closure member adapted to sealingly mount in said second manifold and said second filter cartridge having a second filter cartridge housing dimensioned to securely maintain said seating by a close cooperation of an outer dimension of a first portion of said second filter cartridge housing with an inner dimension of said throughhole.

3. The apparatus of claim 2 wherein said filter cartridges are tapered with an outer diameter of said filter cartridge housing being narrower towards said closure member.

4. The apparatus of claim 1 further comprising at least one sleeve within said mounting bracket, said sleeve being disposed to guide a closure member of a filter cartridge into seating with one of said first or second manifolds during installation of the cartridge.

5. The apparatus of claim 1 further comprising a cap removably securable to said mounting bracket over a base end of each of said first and second filter cartridge housings, when said first and second filter cartridge housings are mounted in the mounting bracket.

6. The apparatus of claim 5 wherein said cap is provided with a lock disposed to lock said cap in place on said mounting bracket.

7. The apparatus of claim 1 further comprising at least one helical ramp on each of said first and second manifolds and at least one helical ramp on each of said closure members of said first and second filter cartridges, said manifold ramps and said cartridge ramps being dimensioned to engage in close cooperation to seat said filter cartridges in said manifolds such that fluid communication through said filter is established between said manifold inlets and said manifold outlets.

8. The apparatus of claim 1 wherein a base end of each of said first and second filter cartridge housing includes a twist fin.

9. The apparatus of claim 1 further comprising at least one O-ring or O-ring seat disposed to seal the closure member of at least one filter cartridge in at least one of said first or second manifold.

10. The apparatus of claim 1 wherein at least one of said manifolds has a first level and a second level, said first level and said second level corresponding to a first level and a second level on the closure member of one of the first or second filter cartridges, and said first and said second levels putting said fluid inlet and said fluid outlet of said manifold in fluid communication with a filter within the filter cartridge.

11. The apparatus of claim 1 wherein each of said inlets of said manifolds is dimensioned to establish fluid communication with a radial inlet port on one of the closure members of one of the filter cartridges.

12. The apparatus of claim 1 wherein at least one of said fluid outlets of said first or second manifolds is oriented to establish fluid communication with an axial outlet port on a top of one of the closure members of one of the filter cartridges.

13. The apparatus of claim 1 wherein said mounting bracket has a back surface including fixtures for wall mounting.

14. The apparatus of claim 1 wherein said mounting bracket fully encloses each of the filter cartridge housings when the filter cartridge housings are fully installed in said mounting bracket.

15. The apparatus of claim 1 wherein said manifolds and said mounting bracket are integrally formed.

16. The apparatus of claim 1 further comprising:
a first fluid inlet stop operatively engaged with said first fluid inlet of said first manifold;
a first fluid outlet stop operatively engaged with said first fluid outlet of said first manifold;
a second fluid inlet stop operatively engaged with said second fluid inlet of said second manifold; and
a second fluid outlet stop operatively engaged with said second fluid outlet of said second manifold.

17. The apparatus of claim 16 wherein each of said stops is disposed to be actuated by said closure members of said filter cartridges upon seating of said closure members of said cartridge filters in said manifolds.

18. A method of constructing a dual fluid filter mounting bracket comprising:
recessing within a fluid filter mounting bracket a first manifold and a second manifold, each of said manifolds being adapted to receive and seat a closure member on a filter cartridge;
establising a fluid communication from a bracket intake to a first manifold inlet in a first manifold, from a first fluid outlet in said first manifold to a second fluid inlet on a second manifold and from a second fluid outlet on said second manifold to a bracket output;
aligning a first throughhole and a second throughhole in said bracket substantially opposite said first and second manifolds, said throughholes each being dimensioned to secure a filter cartridge housing in said bracket when said closure members of said filter cartridges are seated in said manifolds.

19. The method of claim 18 further comprising:
providing a first filter cartridge having a closure member adapted to sealingly mount in said first manifold and said first filter cartridge having a first filter cartridge housing dimensioned to securely maintain said seating by a close cooperation of an outer dimension of a first portion of said first filter cartridge housing with an inner dimension of said first throughhole; and
a second filter cartridge having a closure member adapted to sealingly mount in said second manifold and said second filter cartridge having a second filter cartridge housing dimensioned to securely maintain said seating by a close cooperation of an outer dimension of a first portion of said second filter cartridge housing with an inner dimension of said second throughhole.

20. The method of claim 18 further comprising:
tapering said filter cartridge housings with an outer diameter of said filter cartridge housing being narrower towards said closure member.

21. The method of claim 18 further comprising:
installing at least one sleeve within said mounting bracket, said sleeve being disposed to guide a closure member of a filter cartridge into seating with one of said first or second manifolds during installation of the cartridge.

22. The method of claim 18 further comprising:
providing a cap removably securable to said mounting bracket over a base end of each of said first and second filter cartridge housings, when said first and second filter cartridge housings are mounted in the mounting bracket.

23. The method of claim 18 further comprising:
providing a lock disposed to lock said cap in place on said mounting bracket.

24. The method of claim 18 further comprising:
fabricating at least one helical ramp on each of said first and second manifolds and at least one helical ramp on each of said closure members of said first and second filter cartridges, said manifold ramps and said cartridge ramps being dimensioned to engage in close cooperation to seat said filter cartridges in said manifolds such that fluid communication through said filter is established between said manifold inlets and said manifold outlets.

25. The method of claim 18 further comprising:
providing a twist fin on a base end of each of said first and second filter cartridge housings.

26. The method of claim 18 further comprising:
including at least one O-ring or O-ring seat disposed to seal the closure member of at least one filter cartridge in at least one of said first or second manifolds.

27. The method of claim 18 further comprising:
fabricating on at least one of said manifolds a first level and a second level, said first level and said second level corresponding to a first level and a second level on the closure member of one of the first or second filter cartridges, and said first and said second levels putting said fluid inlet and said fluid outlet of said manifold in fluid communication with a filter within the filter cartridge.

28. The method of claim 18 further comprising:
dimensioning each of said inlets of said manifolds to establish fluid communication with a radial inlet port on one of the closure members of one of the filter cartridges.

29. The method of claim 18 further comprising:
orienting at least one of said fluid outlets of said first or second manifolds to establish fluid communication with an axial outlet port on a top of one of the closure members of one of the filter cartridges.

30. The method of claim 18 further comprising:
fabricating on said mounting bracket a back surface including fixtures for wall mounting.

31. The method of claim 18 further comprising:
dimensioning said mounting bracket such that mounting bracket fully encloses each of the filter cartridge housings when the filter cartridge housings are fully installed in said mounting bracket.

32. The method of claim 18 further comprising:
integrally forming said manifolds and said mounting bracket.

33. The method of claim 18 further comprising:
operatively engaging a first fluid inlet stop with said first fluid inlet of said first cartridge, and a first fluid outlet stop with said first fluid outlet of said first manifold; and
operatively engaging a second fluid inlet stop with said second fluid inlet of said second manifold and a second fluid outlet stop with said second fluid outlet of said second manifold.

34. The method of claim 33 further comprising:
disposing each of said stops such that seating of said closure members of said filter cartridges in said manifolds operatively engages said stops.
